(19) United States
(12) Patent Application Publication
(10) Pub. No.: US 2009/0238744 A1
(43) Pub. Date: Sep. 24, 2009

(54) Catalyst System for CO-Removal

(76) Inventors: Albert N. Chigapov, Aachen (DE); Brendan Patrick Carberry, Aachen (DE)

Correspondence Address: FORD GLOBAL TECHNOLOGIES, LLC, FAIRLANE PLAZA SOUTH, SUITE 800, 330 TOWN CENTER DRIVE, DEARBORN, MI, 48126, US

(21) Appl. No.: 12/406,647

(22) Filed: Mar. 18, 2009

(30) Foreign Application Priority Data
Mar. 19, 2008 (EP) 08102761.7

(51) Int. Cl. B01D 53/62

(52) U.S. Cl. 423/247; 422/171

(57) ABSTRACT

The invention relates to a catalyst system for the removal of carbon monoxide from a hydrogen containing feed gas. The system includes a first catalyst optimised to selectively oxidize carbon monoxide in the feed gas at temperatures below 100° C. The system also includes a second catalyst, downstream from the first catalyst, optimised to selectively oxidize carbon monoxide in the feed gas at temperatures above 100° C., the second catalyst having a higher carbon monoxide conversion rate than the first catalyst at 100° C.

### BACKGROUND OF THE INVENTION

The present invention relates to a catalyst system for removal of carbon monoxide (CO) from hydrogen-rich feed gas.

The invention relates to carbon monoxide elimination from hydrogen-rich gas for fuel cells to prevent carbon monoxide poisoning of electrodes, but it may also be applied for other areas where low-temperature carbon monoxide elimination is required. This might be for example automotive applications, air cleaning systems for indoor air quality control, e.g. carbon monoxide removal at ambient temperatures in tunnels, metro, parking areas, garages, submarines, but also for respiratory protection systems. It maybe used basically for automotive applications, but is also suitable for stationary applications in industry, like purification of gases for chemical plants, power generation plants and stationary engines, for example for ammonia plants, polymerization reactions of hydrocarbons and for CO₂ laser technology processes.

Reduction of CO₂ emissions from industrial processes is a goal of many countries and industries. Hydrogen as a fuel without producing CO₂ one solution to reduce the amount of CO₂ produced. In-situ production of hydrogen from reforming alcohols or hydrocarbons, especially methane and diesel fuel, combined with WGSR (water-gas-shift-reaction) is one method of supplying fuel cells with fuel.

Solid oxide fuel cells (SOFC) have 70-80% system efficiency (including heat usage), electrical power plants using combustion have 30-37% system efficiency; transportation proton-exchange membrane fuel cells (PEMFC) have 40-50% system efficiency while internal combustion (IC) engines have 20-35% system efficiency. Polymer electrolyte membrane fuel cells (PEMFCs) are compact, having high power density and low temperature operation, but suffer from electrode poisoning (anode catalysts Pt, Pt—Ru) by carbon monoxide when the carbon monoxide concentration exceeds 20 ppm. It is not possible to completely eliminate carbon monoxide after reforming and WGSR reactions. That is why there is a need to remove carbon monoxide from hydrogen-containing feed-gas mixture.

The most promising method is carbon monoxide oxidation by addition of small amount of oxygen, but highly selective catalysts are required, otherwise a high degree of unwanted H₂-oxidation takes place as well. This is undesirable as this additional H₂-consumption lowers the efficiency of the fuel cell system and increases the H₂-oxidation on the catalyst intended for CO-removal. The increased temperature may damage this catalyst further facilitates unwanted hydrogen oxidation.

Carbon monoxide-removing catalysts for fuel-cell applications are known in the state of the art. All of them are catalytically active at least with respect to the reactions

CO+½O₂→CO₂ (1) and

H₂+½O₂→H₂O (2),

but to a different extent. Equation (1) reflects the desired reaction, which a catalyst should accelerate, whereas equation (2) is the hydrogen oxidation, which is an undesired side reaction in the CO-removing step to clean hydrogen fuel cell feed gas from the catalyst poison carbon monoxide. This side reaction is unwanted, as it leads to hydrogen consumption which therefore cannot be transformed into energy by the fuel cell and also because the hydrogen oxidation is an exothermic reaction which might lead to local over-heating of the catalyst.

Different types of catalysts are proposed by the state of the art. WO2007106664 A2 describes a gold-based catalytic system that is able to reduce the carbon monoxide-content of hydrogen fuel-cell feed gas. Systems of that type however typically show low thermal stability and low stability under reaction conditions with gradual catalyst deactivation. An additional drawback is that these formulations also seem to be sensitive to moisture and CO₂.

Copper-based catalysts like Cu—CeO₂ are also known to be suitable for the elimination of CO from hydrogen-rich fuel-cell feed gas. However, catalysts of this type have slow reaction rates and cannot completely oxidize CO at low temperatures below 150° C., especially if the feed gas has low O₂:CO-ratios less than 1.0. The O₂:CO-ratio is defined here according to the equation

λ=O₂/CO (3)

in which O₂ and CO are corresponding concentrations in the gas mixture before contact with the catalyst system.

Another type of catalyst is based on platinum or platinum group metals (PGM), alloyed with Cobalt and Iron as described in WO2006130574. These catalysts have high conversion rates at relatively low operation temperatures, but their selectivity with regard to carbon monoxide oxidation is quite poor. This leads to the unwanted side reaction of H₂-oxidation. Due to this reason, these catalysts have to be operated with a hydrogen fuel-cell feed gas that contains a relatively high amount of oxygen with O₂:CO-ratios of λ>1.5 or 2.0 to compensate the oxygen consumption by the side reaction as described by equation (2) and thus to ensure that the carbon monoxide concentration maybe lowered beyond the limit of 20 ppm to prevent the poisoning of fuel-cell anode catalyst.

A further drawback of PGM-based catalysts is that complete carbon monoxide removal is only effective within a temperature window which is too narrow for practical operations of fuel cells, where complete carbon monoxide removal from 50 to 200° C. at different space velocities is required. This is important for automotive fuel cell applications due to the rapid change and high variety of temperatures and flows.

Known catalysts don't have the desired temperature and selectivity required of automotive fuel cells. The problem to be solved by the current invention is to create a catalyst that shows good selectivity combined with high carbon monoxide oxidation rates in an atmosphere with small oxygen concentrations. In addition to that, the catalyst should be resistant to higher temperatures and corrosion and should be effective over a wide temperature range of fuel-cell operation modes.

### SUMMARY OF THE INVENTION

This problem is solved by a catalytic system which is composed of at least two different catalysts which are consecutively combined to form a catalyst system. One of the catalysts has a high selectivity with respect to carbon monoxide oxidation whereas the second catalyst, located downstream has a lower selectivity but high activity. These two catalysts are not mixed but combined to a binary catalytic system.

The advantage of such a catalyst system is that the catalyst may be operated at lower temperatures and over a wider temperature window from below 80° C. to more than 220° C. with high conversion rates and higher selectivity with respect to carbon monoxide oxidation. In addition, such a system may operate with a lower amount of oxygen for carbon monoxide oxidation, thus minimising hydrogen oxidation.

A first embodiment of the current invention is therefore a catalytic system suitable for carbon monoxide removal from hydrogen and oxygen containing fuel cell feed gas comprising at least two locally separated catalyst materials C₁ and C₂, wherein the first catalyst material C, shows at a temperature of 100° C. a higher selectivity with respect to carbon monoxide oxidation than the second catalyst material C₂ and/or the second downstream catalyst material C₂ shows at a temperature of 100° C. a higher conversion rate with respect to carbon monoxide oxidation than the first catalyst material C₁.

The conversion rate with respect to carbon monoxide oxidation is measured and calculated according to the equation

X_{CO}=(COᵢₙ−COₒᵤₜ)/COᵢₙ×100% (4)

wherein COᵢₙ and COₒᵤₜ are inlet and outlet carbon monoxide concentrations before contact with catalyst system (COᵢₙ) and after contact with the catalyst system (COₒᵤₜ).

The conversion rate of oxygen is calculated according to the equation

X_{O2}=(O_{2 in}−O_{2 out})/O_{2 in}×100% (5)

wherein O₂ in and O_{2 out} are inlet and outlet oxygen concentrations before contact with catalyst system (O_{2 in}) and after contact with the catalyst system (O_{2 out}).

The selectivity with respect to carbon monoxide oxidation is calculated according to the equation

S=2X_{CO}/X_{O2}×100% (6).

Preferably, the first catalyst material C₁ shows at an oxygen:carbon monoxide ratio of λ=1.5, a higher selectivity with respect to carbon monoxide oxidation than the second catalyst material C₂ and/or the second catalyst material C₂ shows at an oxygen:carbon monoxide ratio of λ=1.5, a higher conversion rate with respect to carbon monoxide oxidation than the first catalyst material C₁. Under these circumstances, conversion rate and selectivity of the catalyst materials may be compared well in respect to real working conditions of a hydrogen fuel cell.

According to a preferred embodiment of the catalyst system, the first catalyst material C, contains a mixture of copper and an oxide from a first metal Me¹, wherein Me¹ is selected from the group comprising Mn, Ce, Zr, Al, Si, Sn, Ti, Zn, Fe, Co, Ni or mixtures thereof. Cu—MnO₂ and Cu—CeO₂ are preferred, because these catalysts increase the overall selectivity of the catalyst system according to the current invention.

According to a further preferred embodiment of the catalyst system, the second catalyst material C₂ contains a mixture of platinum and a second metal Me², whereas Me² is selected from the group comprising Fe, Ru, Co, Rh, Ir, Ni and Pd or mixtures thereof. It is preferred that the metal Me² is cobalt, iron or a mixture of cobalt and iron, revealing Pt—Co, Pt—Fe and Pt—Co—Fe as preferred catalyst materials for C₂. These catalyst materials are preferred, because those compositions show the best overall results in a catalytic system according to the invention, especially with respect to reaction velocity even at low O₂:CO-ratios of λ=<1.0.

With respect to the catalyst system according to the current invention, a binary catalyst system is preferred, (i.e., a catalyst system consisting of one first catalytic material with high selectivity to CO-oxidation and one second catalytic material with high reactivity according to CO-oxidation). A combination of Cu—MnO₂ as C₁ with Pt—Co as C₂ is especially preferred.

The catalysts according to this invention may be deposited on a catalyst support. The material of the support structure is in principle not subject to any restrictions and includes silica, zirconium dioxide (ZrO₂), zirconium phosphate, alumina, cerium oxide (CeO₂) and mixtures thereof.

According to a preferred embodiment of the catalyst system, the catalyst material C₁ is located upstream of the catalyst material C₂ with respect to the flow direction of the gas. This arrangement is preferred if the gas mixture, from which carbon monoxide is to be removed flows over or through the catalyst system. For this purpose, the catalyst system may be implemented into a tube-like structure using a stationary bed catalyst that works as reactor for carbon monoxide removal. The reactor has an inlet channel through which the untreated feed gas mixture enters the reactor and an outlet channel through which the gas mixture leaves the reactor in direction to a hydrogen fuel cell for example.

This arrangement is preferred as under these circumstances, the highest synergistic effect of using two different types of catalysts separated from each other is observed with respect to selectivity and reactivity. Comparative tests with mixtures of these catalysts, i.e. a mixture of C₁ and C₂ on the same substrate revealed practically no improvement in comparison to the single catalysts.

It is further preferred to deposit the catalysts on a monolith honeycomb structure as substrate to provide low back pressure and convenient carbon monoxide oxidation under fuel cell conditions. These structures can be integrated into a gas reactor and can be installed before the fuel cell inlet and after the water-gas shift reaction section or can be integrated into a fuel cell.

A further embodiment of the current invention is a gas reactor for oxidizing carbon monoxide comprising a catalyst system according to the current invention. The gas reactor can be realized as tube-like structure, with an inlet and an outlet channel. The outlet channel can be connected to the feed-gas inlet of a hydrogen fuel cell. With such an arrangement, a fuel cell can be operated continuously while protecting the catalyst material of the fuel cell from being poisoned by carbon monoxide, which is continuously removed from the feed gas mixture by the gas reactor according to the current invention.

Another embodiment of the current invention is a method for carbon monoxide removal from a gas mixture in which the gas mixture is brought into contact with a catalyst system or a reactor according to this invention. This method is carried out in such a way that the gas mixture, from which carbon monoxide is to be removed, is brought into contact at least with two different catalysts after one another. Preferably, the gas is contacted first with a catalyst which shows high selectivity with respect to carbon monoxide oxidation and then consecutively with a second catalyst which has a high activity according to carbon monoxide oxidation. The gas mixture can flow continuously over or through the catalyst system or the reactor, respectively.

Complete carbon monoxide removal may be obtained with a gas mixture containing oxygen in an amount which is higher or equal to half of the carbon monoxide concentration (i.e., λ=0.5). Good results may be obtained, if the O₂:CO-ratio of the fuel cell feed gas is between 2.0 to 0.5, especially from 1.5 to 0.7. Values for λ between 1.0 and 0.7 are mostly preferred because a hydrogen fuel cell feed gas mixture with such O₂:CO-ratios may be effectively cleaned from carbon monoxide while consuming only very little hydrogen at the same time.

In a preferred embodiment of the current method, the catalyst system temperature is kept in a range from 80 to 220° C., especially from 100 to 200° C. This is achieved by typical means like heating or cooling which is controlled with the help of a thermocouple. Typically hot feed gas having a temperature of 220-270° C. maybe obtained from the WGSR reactor which then enters the working fuel cell. The operating temperature of a fuel cell is typically 80-120° C. This temperature range is preferred by the catalyst system to almost completely remove carbon monoxide from fuel cell feed gas. This broad temperature range is especially useful automotive fuel cell catalyst systems. Under these operation conditions, the system removes carbon monoxide over a broad temperature range with different space velocities. Both are required due to the rapid change and wide variety of temperatures and flow rates of the fuel cell feed gas.

According to another embodiment of the current method, the space velocity of the gas is lower for the first catalyst material C₁ than for the second catalyst material C₂. This maybe realized using higher catalyst loading and respectively higher length of catalyst layer for C₁ than for C₂. So as the C₁ is low-cost copper-based catalyst while C₂ is containing expensive Pt, it does not increase practically the cost of the system to purify hydrogen-rich gas. Typical loading was 140 mg of C₁ and only 15 mg of C₂ for standard fuel cell having PEMFC polymeric membrane of 25 cm² and producing current 0.3 A/cm² Lower space velocities in the part of the catalyst system C₁ increase the overall selectivity of the catalyst system proportionally.

Another embodiment of the current invention is the use of a catalyst system or a reactor according to this invention for carbon monoxide removal from a gas mixture which contains carbon monoxide and oxygen. As already mentioned above, the catalyst system according to this invention cannot only be used to clean hydrogen fuel cell feed gas from carbon monoxide but also is also suitable for other applications, in which CO-containing gas mixtures have to be cleaned from carbon monoxide.

The invention is described in greater detail hereinafter by means of preferred embodiments by way of example and with reference to the accompanying Figures.

### BRIEF DESCRIPTION OF THE DRAWINGS

FIG. 1 is the layout of a binary catalyst installation in a reactor.

FIG. 2a is a graph showing the activity of different catalysts in an atmosphere with λ=1.5 (ratio O₂/CO).

FIG. 2b is a graph showing the selectivity to carbon monoxide oxidation of different catalysts in an atmosphere λ=1.5 (ratio O₂/CO).

FIG. 3a is a graph showing the activity of different catalysts in an atmosphere with λ=1.0 (ratio O₂/CO).

FIG. 3b is a graph showing the selectivity to carbon monoxide oxidation of different catalysts in an atmosphere with λ=1.0 (ratio O₂/CO).

FIG. 4a is a graph showing the activity of different catalysts in an atmosphere with λ=0.7 (ratio O₂/CO).

FIG. 4b is a graph showing the selectivity to carbon monoxide oxidation of different catalysts in an atmosphere with λ=0.7 (ratio O₂/CO).

### DETAILED DESCRIPTION OF THE PREFERRED EMBODIMENTS

### EXAMPLES

### Preparation of Pt—Co catalyst on alumina

The high-surface area alumina was supplied from Alfa Aesar. The surface area was 255 m²/g after preliminary calcinations at T=750° C. The alumina support was then impregnated with a hot solution (85° C.) containing tetraamineplatinum (II) nitrate, cobalt nitrate and tartaric acid using so-called “wetness impregnation”. Tartaric acid was added in a slight excess (1.2 of stoichiometric molar ratio of tartatic acid/Pt+Co). Pt loading was selected as 5 wt %, and Co loading was 1.5 wt % accordingly. The samples were dried at 77° C. in drying box overnight and then were finally calcined at 550° C. for 2 hours in the air.

### Cu—MnO₂ catalyst preparation

The Preparation Procedure Contains Three Steps, Namely:
1) Co-precipitation of copper and manganese mixed oxide from the mixture of manganese (II) nitrate and copper nitrate (2/1 molar ratio Mn/Cu) using excess of potassium carbonate as a precipitation agent at room temperature with the following stirring. 45 g (total) of copper and manganese nitrates were dissolved in 200 ml of distilled water and added drop wise to the solution containing excess of precipitating agent in 300 ml of distilled water under intensive stirring. Then the sample was dried at 100° C. and calcinated at 200° C. overnight and finally at 350° C. for 2 h.
2) To create a highly porous MnO₂, Cu was then removed from mixed oxide by big excess of 35% nitric acid at room temperature for one day under stirring with the following decantation and washing with distilled water on filter, with final drying at room temperature. Typically, 50 ml of nitric acid was used twice diluted with distilled water before the treatment. The surface area of MnO₂ prepared by this method—was 220 m²/g. The steps 1 and 2 maybe described by the following equation:

Cu⁺², Mn⁺²+CO₃^{-2(deposition)}→(Cu, Mn) CO₃↓⁻)→Cu—MnO₂^{(calcinations)}→MnO2^{(HNO}₃)
3) Reinsertion of smaller amounts of copper (5-15 mol %) to the solid MnO₂ obtained by steps 1 and 2, by wetness impregnation with copper nitrate solution with the following drying at 100° C. and final calcination at 350° C. for two hours. For wetness impregnation, the designated amount of copper nitrate was dissolved in a minimal amount of distilled water (1.5-2 ml) to get a required copper loading of 10%.

### Testing

All catalysts were tested in a laboratory-scale packed-bed flow reactor made from a 1 cm ID×5 cm L quartz tube. An electric furnace was used to heating the reactor. The temperature was monitored by a thermocouple placed in the centre of the catalyst bed.

A powdered catalyst sample with catalyst loading of 10-500 mg depending on catalyst density was diluted with 1 cm³ quartz sand, then was inserted into the reactor and exposed to feed gas mixtures comprising the following gases: 0.6 vol.-% CO, varied content of 0.43-0.9 vol.-% O₂, 27 vol.-% H₂O, 15.5 vol.-% CO₂, 55 vol.-% H₂, N₂-balance (methane reforming gas mixture after WGSR) for selective carbon monoxide oxidation in the presence of hydrogen for fuel cell applications. A conventional flow setup was used for gas mixture preparation.

All gases were of ultra high purity. Humidifier was installed to provide accurate water concentration in the gas line. The flow rates were controlled using mass flow controllers (MKS, Munich, Germany). To prevent water condensation, all connection lines for PROX study were installed in a thermal box maintaining constant temperature of 85° C. Reactor effluents were analyzed with a HP 6890A gas chromatograph, using Porapak Q and NaX capillary columns.

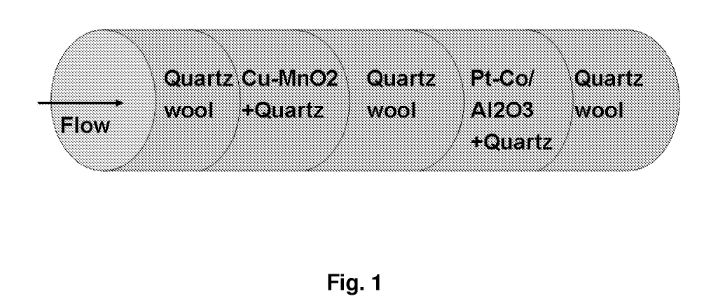

Before testing, Pt—Co catalysts were reduced in the reaction mixture at 165° C. for 15 minutes with the following cooling. The design of the reactor with binary catalyst is described in FIG. 1.

Typically, 0.015 g of Pt—Co/Al₂O₃ catalyst was diluted with quartz sand (0.2 mm fraction) to 1 ml volume. For Cu—MnO₂, 0.14 g of catalyst was mixed with quartz sand.

### Brunauer, Emmett and Teller (BET) Surface Area Evaluation

BET surface areas were measured by N₂ adsorption at 77K using Micromeritics 2010 ASAP instrument.

### XRD Analysis

XRD study was carried out using DRON 4 diffract meter with Cu Kα radiation. XRD patterns were recorded in the ranges of 1-7° (2θ) with a step of 0.04° (2θ).

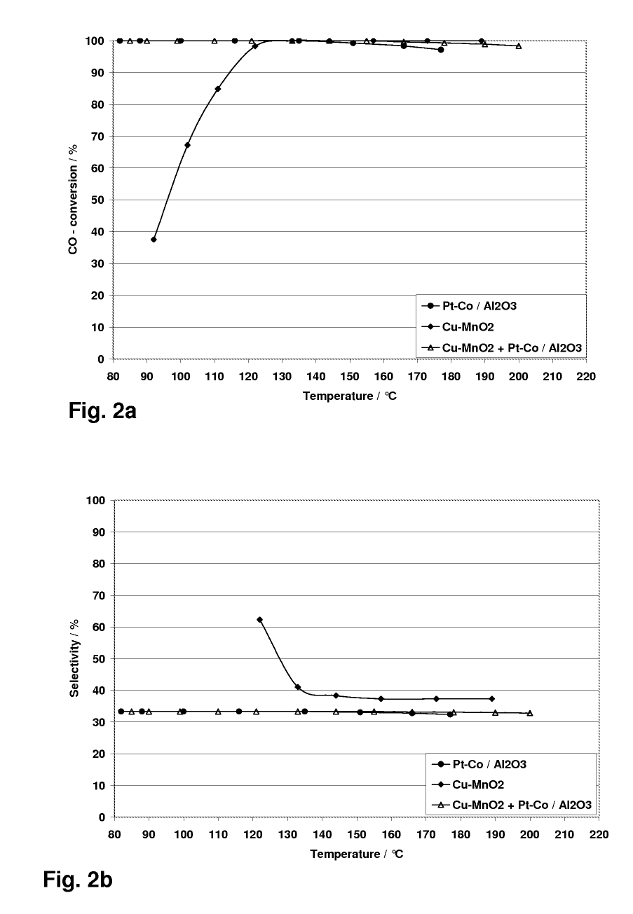

FIGS. 2a to 4b are the performance of a binary catalyst system with the catalyst of higher selectivity upstream of the catalyst with higher activity in comparison to single catalysts. The reaction has been carried out under the same conditions except for oxygen concentration, which varied from 0.42 to 0.9 vol % with λ value varied from 0.7 to 1.5 correspondingly. The space velocity was maintained constant 15000 h⁻¹ for Cu—MnO₂ single catalyst; 100000 h⁻¹ for Pt—Co/alumina catalyst and for the binary catalyst according to the current invention 17000 h⁻¹ for the Cu—MnO₂ part and 100000 h⁻¹ for Pt—Co/alumina part, so the overall space velocity was 15000 h⁻¹ for binary catalyst to be comparable to the Cu—MnO₂ single catalyst.

FIG. 2a is the activity and FIG. 2b is the carbon monoxide selectivity of a binary catalyst (Cu—MnO₂+Pt—Co/alumina) according to the invention in comparison to the individual Cu—MnO₂ and Pt—Co-alumina catalysts in selective carbon monoxide oxidation using λ=1.5 (ratio O₂/CO).

The reaction mixture used consists of 0.6 vol.-% CO, 0.9 vol.-% O₂, 27 vol.-% H₂O, 15.5 vol.-% CO₂, 55 vol.-% H₂, N₂-balance to 100 vol.-%. The space velocity SV=15 000 h⁻¹ for Cu—MnO₂ catalyst (0.15 g), SV=100 000 h⁻¹ for Pt—Co/alumina catalyst (0.014 g) and SV=15000 h⁻¹ for the binary catalyst according to the current invention (SV=17 000 h⁻¹ for Cu—MnO₂ part and SV=100 000 h⁻¹ for Pt—Co/alumina part).

The reaction described in FIGS. 2a and 2B is carried out using an excess of oxygen, the performance of single Pt—Co/alumina catalyst is close to that of the binary catalyst system according to the invention, both reaching complete carbon monoxide removal at 80° C. Under these conditions of relatively high oxygen content with λ=1.5, the selectivity of carbon monoxide oxidation is near equal for both catalysts.

The binary catalyst system shows a wider temperature window of complete carbon monoxide elimination up to 180° C., while for single Pt—Co/alumina catalyst, carbon monoxide removal decreases at temperatures above 150° C. Cu—MnO₂ single catalyst reaches complete carbon monoxide removal at 130° C. whereas carbon monoxide selectivity is significantly higher until this temperature is reached.

Summarizing, Pt—Co/alumina single catalyst may cope with carbon monoxide elimination under fuel cell conditions using the large excess of oxygen in comparison to the carbon monoxide concentration. However, the selectivity of carbon monoxide oxidation is only 33% which means that for each eliminated carbon monoxide molecule two molecules of hydrogen were also oxidized. Cu—MnO₂ shows effective carbon monoxide elimination at temperatures above 130° C. The binary catalyst system according to the current invention produces complete carbon monoxide oxidation over a wide temperature range.

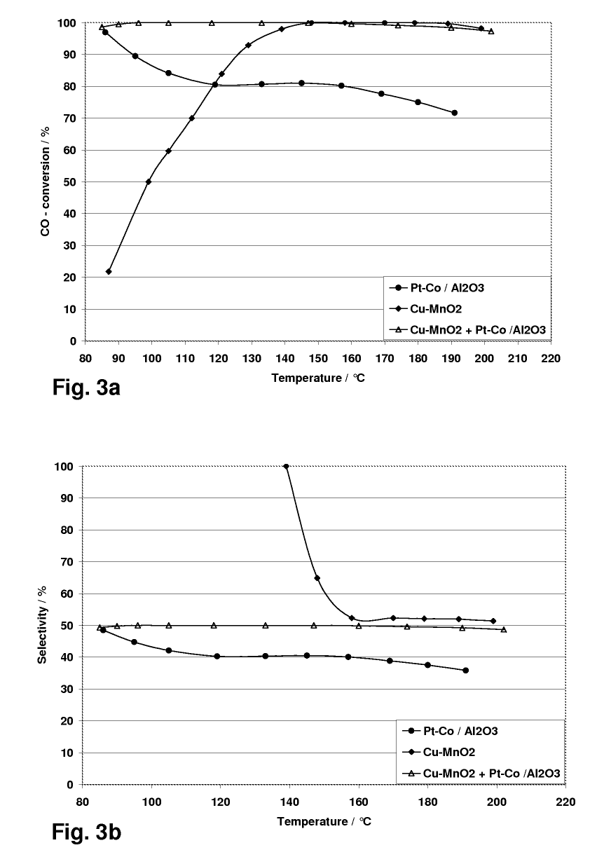

FIG. 3a displays the activity and FIG. 3b the carbon monoxide selectivity of a binary catalyst (Cu—MnO₂+Pt—Co/alumina) according to the invention in comparison to the individual Cu—MnO₂ and Pt—Co-alumina catalysts in selective carbon monoxide oxidation using λ=1.0.

The reaction mixture used consists of 0.6 vol.-% CO, 0.6 vol.-% O₂, 27 vol.-% H₂O, 15.5 vol.-% CO₂, 55 vol.-% H₂, N₂-balance to 100 vol.-%. The space velocity SV=15 000 h⁻¹ for Cu—MnO₂ catalyst (0.15 g), SV=100 000 h⁻¹ for Pt—Co/alumina catalyst (0.014 g) and SV=15000 h⁻¹ for the binary catalyst according to the invention (SV=17 000 h⁻¹ for Cu—MnO₂ part and SV=100 000 h⁻¹ for Pt—Co/alumina part).

With lower oxygen content in comparison to the carbon monoxide concentration presented on FIGS. 2a and 2b. FIGS. 3a and 3b represent the catalyst performance in an atmosphere with a lower amount of oxygen with λ=1, the Pt—Co/alumina single catalyst does not provide complete carbon monoxide elimination at all temperatures due to the low selectivity of carbon monoxide oxidation.

Cu—MnO₂ single catalyst shows complete carbon monoxide removal only at rather high temperatures of 150-190° C. In contrast to single oxide catalysts, the binary catalyst reveals wide temperature window of complete carbon monoxide removal under these conditions, from near 95° C. up to 180° C. The selectivity of CO oxidation is significantly higher for binary catalyst than for Pt—Co/alumina catalyst.

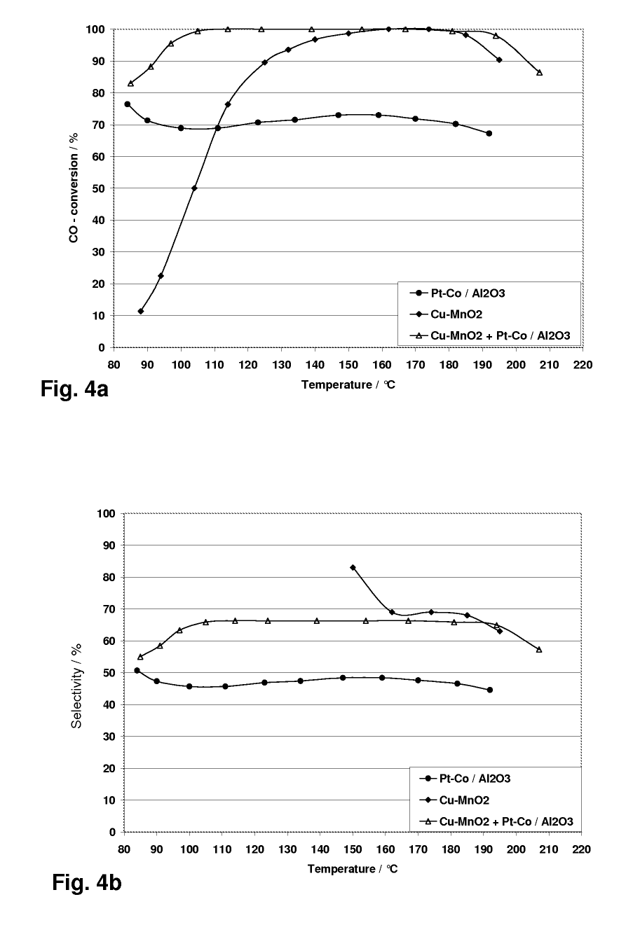

FIG. 4a shows the activity and FIG. 4b the carbon monoxide selectivity of a binary catalyst (Cu—MnO₂+Pt—Co/alumina) according to the invention in comparison to the individual Cu—MnO₂ and Pt—Co-alumina catalysts in selective carbon monoxide oxidation using λ=0.7 (ratio O₂/CO).

The reaction mixture used consists of 0.6 vol.-% CO, 0.42 vol.-% O₂, 27 vol.-% H₂O, 15.5 vol.-% CO₂, 55 vol.-% H₂, N₂-balance to 100 vol.-%. The space velocity SV=15 000 h⁻¹ for Cu—MnO₂ catalyst (0.15 g), SV=100 000 h⁻¹ for Pt—Co/alumina catalyst (0.014 g) and SV=15000 h⁻¹ for the binary catalyst according to the invention (SV=17 000 h⁻¹ for Cu—MnO₂ part and SV=100 000 h⁻¹ for Pt—Co/alumina part).

FIGS. 4a and 4b show the results with the lowest O₂ to CO-ratio of λ=0.7. A Pt—Co/alumina single catalyst is only able remove about 70% of carbon monoxide under these conditions, Cu—MnO₂ single catalyst hardly reaches complete carbon monoxide removal only at very high 165° C.-170° C., while binary catalyst still provides a wide temperature window of complete carbon monoxide removal under these conditions over the whole range from 105° C. to 180° C.

Summarizing, the binary catalyst, which includes a Cu—MnO₂ catalyst placed upstream of a Pt—Co/alumina catalyst in a gas mixture produces superior CO conversion rates and selectivity relative to single catalysts of Cu—MnO₂ or Pt—Co/alumina.

The catalyst systems according to the current invention have a wider temperature range for complete carbon monoxide removal under typical fuel cell operation conditions. The advantages over the single type catalysts become more pronounced with decreasing oxygen concentration and A (ratio O₂/CO), i.e. conditions that are highly appreciated as under these conditions less hydrogen is oxidized due to side reactions as presented in equation (2).

The catalyst systems according to this invention open the opportunity to carry out selective carbon monoxide oxidation in the presence of hydrogen to protect the fuel cell catalysts from carbon monoxide poisoning with minimal excess of oxygen and minimal hydrogen consumption. The further advantage of the current system is that it maybe operated over a wide temperature range in which complete carbon monoxide removal maybe maintained.

The reason of such synergy between two locally separated catalysts, especially in the order that the more selective catalyst C₁ (especially Cu—MnO₂) is positioned upstream from the higher active catalyst C₂ (especially Pt—Co) is not completely understood. While not wishing to be bound to the following theory, it is speculated the gas mixture first contacts the more selective catalyst C₁ oxidizes part of the carbon monoxide with some oxygen consumption creating more favourable conditions for the second, more active catalyst C₂.

What is claimed:

1. A catalyst system for carbon monoxide removal in feed gas comprising;
a first catalyst optimised to selectively oxidize carbon monoxide in the feed gas at temperatures below 100° C.; and
a second catalyst, downstream from the first catalyst, optimised to selectively oxidize carbon monoxide in the feed gas at temperatures above 100° C.,l the second catalyst having a higher carbon monoxide conversion rate than the first catalyst at 100° C.

2. The catalyst system of claim 1, wherein the first catalyst material is a first metal selected from the group comprising: Mn, Ce, Zr, Al, Si, Sn, Ti, Zn, Fe, Co, Ni and mixtures thereof.

3. The catalyst system of claim 1, wherein the second catalyst material is a second metal selected from the group comprising: Fe, Ru, Co, Rh, Ir, Ni and Pd and mixtures thereof.

4. The catalyst system of claim 1 wherein the first and second catalysts are deposited on a honeycomb structure support.

5. The catalyst system of claim 1, wherein the feed gas contains hydrogen.

6. A method of removing carbon monoxide from an oxygen containing feed gas comprising the steps of:
contacting the feed gas with an O₂:CO-ratio of between 2.0 to 0.7 with a catalyst system having a first catalyst optimised to selectively oxidize carbon monoxide in the feed gas at temperatures below 100° C.; and a second catalyst, downstream from the first catalyst, optimised to selectively oxidize carbon monoxide in the feed gas at temperatures above 100° C.,

7. The method of claim 6 wherein the O₂:CO-ratio is between 1.5 to 0.5.

8. The method of claim 6, further comprising the step of maintaining the catalyst system temperature between 80 to 220° C.
